(19) United States
(12) Patent Application Publication
(10) Pub. No.: US 2006/0007016 A1
(43) Pub. Date: Jan. 12, 2006

(54) Utilities and communication integrator

(75) Inventors: Timothy J. Borkowski, Houston, TX (US); Richard L. Grasshoff, Richmond, TX (US); R. Kenneth Murphy, Sugar Land, TX (US); Donato Cortez, Sugar Land, TX (US)

Correspondence Address: ALBERT B. KIMBALL, JR.;BRACEWELL & PATTERSON L L P, 711 LOUISANA SUITE 2900, HOUSTON, TX, 77002, US

(73) Assignee: CenterPoint Energy, Inc., Houston, TX (US)

(21) Appl. No.: 11/153,304

(22) Filed: Jun. 15, 2005

Related U.S. Application Data
(60) Provisional application No. 60/586,786, filed on Jul. 9, 2004.

(51) Int. Cl. G08B 23/00

(52) U.S. Cl. 340/870.02

(57) ABSTRACT

A system measures electrical energy usage and combines the measured energy usage with other utility commodity usage for communication and data collection. The system is capable of metering electrical power utility services to residential homes and apartments or other users and combining electrical usage and other utility metering functions for utilities for multiple utility end users. The system thus integrates and communicates the results of utility usage, and eliminates the need for an individual electric metering device for each end user. The system serves as a single metering data collection point for multiple utilities and facilitates interactive communication technologies between the utility service delivery points and utility consumers or consumer devices. The system also includes a plurality of meter ports and a memory for storing meter data from each metered user. The UCI provides for injection of broadband signals onto the service conductors from multiple broadband sources.

### BACKGROUND OF THE INVENTION

1. Field of the Invention

The present invention relates to metering or measuring of electrical energy usage and data, and to the collection and communication of electrical energy usage and other utility service data (such as gas and water) for multiple customers. The present invention also enables the integration of multiple communication mediums to the home or business via wiring, fiber and wireless communication.

2. Description of the Related Art

So far as is known, the most common method for determining the amount of electricity delivered to a consumer has been to read an electric utility meter (usually measuring kilowatt hours), which was mounted on the home or building of the consumer being served. This arrangement was also usually comparable for both gas and water meters as well, with separate usage meters for each of the commodities provided by those utilities being located on or near the building or property being served. Service charges for those commodities were based on the amounts used, as indicated by the various meters. Because the various utility meters were located at a point where the utility commodity was delivered to the consumer, it became necessary for utility companies to establish meter reading routes composed of a number of user locations. A “meter reader” then periodically visited each meter for a utility on a particular route to record the amount of utility product consumed. The consumer was then periodically billed according to measured utility usage.

At present, many utility companies (including gas, electric, and water) have continued to send meter readers to consumer residences or buildings to collect utility meter readings. However, there are practical limitations on how efficiently this procedure can actually be performed. Personnel and staffing costs of meter reading crews became a concern as the numbers of users increased. Also, since security is a major concern of most homeowners today, access to the actual location of the consumer's meters has heightened security issues with consumer and utilities. Some consideration has thus been given to implementing a self-reporting process where consumers themselves read their usage meters and periodically report usage readings for billing purposes. This, however, gives rise to other concerns. For instance, most consumers have little or no knowledge of how to read their meters, or how to gain access to meters themselves. This directly and adversely impacted the accuracy and efficiency of the self-reporting process.

The typical process of collecting meter data in the manner now in use thus had numerous disadvantages and inefficiencies. Collection of meter data was a labor intensive and costly process. Widespread use was made of electromechanical metering devices which were less expensive than electronic meters. However, electromechanical metering devices generally had little or no communication capability. Each utility, whether electric, gas or water, had its own type of meter for each individual user/consumer, and each utility had its own process for data collection.

There was some thought and effort towards conversion to an automated meter reading (or AMR) system to overcome some of the problems discussed above. However, for AMR applications, electric utilities were still dependent on a separate meter device at the service entrance of a home, apartment or business. AMR applications typically made the utility meters electronically accessible, either to a meter reading device or by individual telemetry connections. The various meters still had to be read individually for automated meter reading or AMR. Thus, in AMR applications, an additional meter reading/communication device, such as a telemetry device in the form of a meter interface unit or telemetry interface unit was required. The meter reading/telemetry device was necessary to receive the meter data and convert it to a suitable format for processing of usage data, and subsequent billing. The AMR process has still not been widely used by most utilities because it is cost prohibitive and was limited to one-way communication, that of reporting usage read from a meter to a data center or site for processing and billing.

### SUMMARY OF THE INVENTION

Briefly, the present invention provides a new and improved usage and data collection unit for utility data one or more consumers. The unit includes one or more electrical sensors which obtain data including the amount of electric energy flowing from a distribution transformer to the consumer for use. The unit also includes a data accumulator to store electrical data for, including usage data, power service provided to the consumer from the distribution transformer. The unit also includes a data transmitter to transmit stored electrical data readings to a data collection facility for billing based on power service provided to the consumer.

The present invention is adapted for use with underground power distribution systems. When the electrical power service to the consumer is by underground distribution, a transformer, or a pedestal having a secondary distribution transformer, serves as a power distribution point. In these underground power distribution systems, the unit according to the present invention is mounted at the power distribution point, either with the transformer or to replace the pedestal separate from the transformer.

The present invention is also adapted for use with overhead power line distribution systems. When the electrical power service to the consumer is by overhead power lines, pole-mounted secondary distribution transformers serve as a power distribution point. In these systems, the unit according to the present invention is mounted at the power distribution point, either with the transformer on the pole, or on the pole separate from the transformer.

The unit according to the present invention is adapted to measure energy usage by a number of consumers or users, and for this purpose includes a plurality of meter ports for the various users. The data accumulator of the unit takes the form of a memory for storing data from each metered user. The user or consumer can readily access energy usage data via a local meter display either located on the utility and communication integrator (or UCI), or located on or in the home or office. Usage information will also be readily available through the Internet. In one embodiment, the unit measures electric kilowatt-hour consumption for multiple consumers and stores that information in memory for real-time or future retrieval. The unit of the present invention is also adapted to collect consumption information from other meter devices for other commodities (such as gas and water) through the data accumulator, and stores that information in memory for real-time or future retrieval. Consumers can readily access and/or receive usage information regarding demand, time of use, reliability, marketing and utility messages regarding product quality, or service interruption, or other such information. The unit of the present invention also serves as a host device so that the data transmitter is able to transmit multiple metering data using one or more of a number of types of telecommunication technologies. The telecommunication technologies which can be used for data transmission include wire, coaxial cable, fiberoptic cable, broadband powerline carrier (also known as BPL), power line carrier (also known as PLC), Wireless Fidelity (also known as WIFI), and others.

The present invention also enables the integration of multiple communication media to the home or business via wiring, fiber and wireless communications. Data transmission with the present invention through the telecommunications technologies makes available one or two-way interactive communication between a unit according to the present invention, and the consumer/user, and utilities or others.

### BRIEF DESCRIPTION OF THE DRAWINGS

A better understanding of the present invention can be obtained when the detailed description set forth below is reviewed in conjunction with the accompanying drawings, in which:

FIG. 1 is a schematic diagram of a prior art service and metering arrangement for electric power to a consumer via underground residential distribution.

FIG. 2 is a schematic diagram of a prior art service and metering arrangement for electric power to a consumer via overhead distribution.

FIG. 3 is a schematic diagram of a service arrangement for delivery of electric power with a unit for metering and communication of utility data and communications services according to the present invention.

FIG. 4 is an example plan view of a typical electrical power distribution arrangement to multiple consumers with delivery of electric power and a unit (UCI) for metering of power and communications with typical meter locations for other utilities according to the present invention.

FIG. 5 is a more detailed schematic diagram of the unit of the present invention in utility service arrangement of FIG. 3 for delivery of electric power and for gathering utility data and facilitating multiple broadband services on service conductors.

FIG. 6 is a block diagram illustrating the flow of information to and from the meter data accumulator.

FIG. 7 is a block diagram of portions of a module according to the present invention and the interactive communication and flow of metering information provided to and from such a module.

To better understand the invention, we shall carry out the detailed description of some of the modalities of the same, shown in the drawings with illustrative but not limited purposes, attached to the description herein.

### DETAILED DESCRIPTION

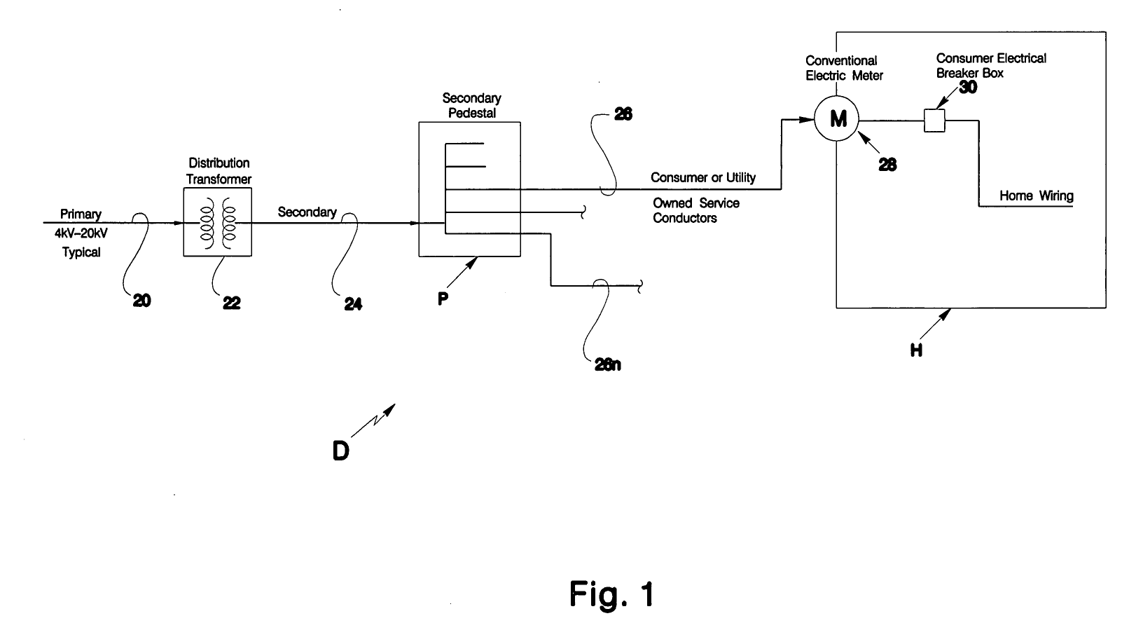

In the drawings, the letter D (FIG. 1) designates generally a conventional, prior art arrangement for distribution and metering to determine the amount of electrical power delivered to a consumer or consumer site, in this instance a home H. In the distribution arrangement D, an example underground residential distribution (URD) arrangement of a typical, conventional type is shown. In the distribution arrangement D, a primary distribution line, usually underground, shown and designated schematically at 20 transports power at a primary voltage, for example 7.2 kilovolts or 19.92 kilovolts to a URD distribution transformer 22. The URD transformer 22 reduces the voltage of power provided to a secondary voltage at a customary rated voltage, volts. The power from the transformer 22 at the customary secondary voltage is transferred by conductors or lines of a secondary distribution line shown schematically at 24 from the transformer 22. In the underground residential distribution arrangement D of FIG. 1, power is delivered to a secondary pedestal P where a number of consumer or utility owned conductors are connected in the conventional manner to transfer power over service conductors, such as shown at 26 to the consumer site H, and through a number of other conductors such as the one shown schematically at 26n to various other consumer sites.

At the consumer site H, a conventional electrical kilowatt hour meter 28 is connected between the service conductor lines 26 and a conventional circuit breaker box 30 at the consumer's home or facility H. The meter 28 may be any one of a number of conventional kilowatt-hour meters, demand meters or other types. Typically, the meter 28 has been mounted on the home or building of the consumer receiving electrical power service from the electrical power company or utility.

The consumer also has typically had a connection and arrangement for receipt of gas and water from other utilities, each of the other utilities being provided with a separate meter for measuring the amount of gas or water or other utility commodity being delivered by that service.

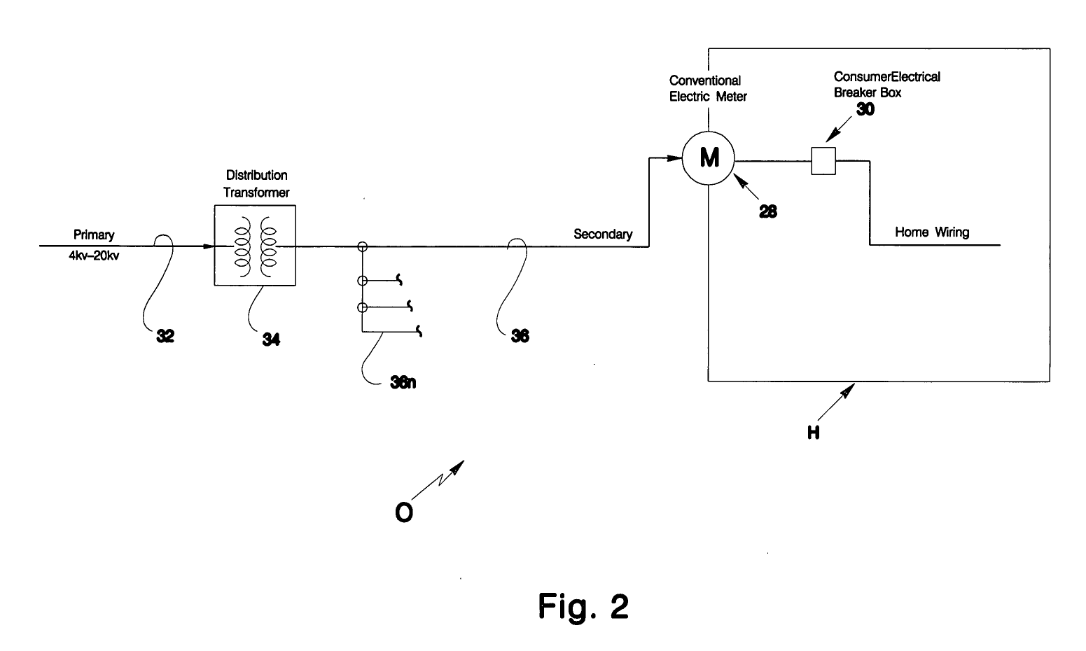

In FIG. 2, the letter O designates generally a conventional prior art arrangement for distribution and metering to a consumer site with an overhead electrical power distribution arrangement. In the overhead distribution arrangement O, an overhead distribution line 32 transports power at comparable levels to those discussed above to a distribution transformer 34 which reduces the voltage of the power to secondary voltage. The distribution transformer 34 is typically mounted at a power distribution pole or other suitable location, and the secondary voltage is furnished from the distribution transformer 34 at a customary rated voltage through a service conductor arrangement shown schematically at 36 to the home or facility H of the consumer. Other consumers are also typically connected through separate service conductors, one of which is shown schematically at 36n.

The arrangement of metering and circuit breaking in the facility or home H of FIG. 2 is like that of the arrangement of FIG. 1, and accordingly the arrangement of FIG. 2 uses like reference numerals for the conventional kilo watt-hour meter 28 and the consumer breaker box 30. Also, the consumer in the arrangement of FIG. 2 has had a similar arrangement for gas, water and other utility connections, again each with a separate meter and requiring separate meter reading arrangements to be made for each such utility service.

Thus, each of the two distribution arrangements described above have had three or more different types of meters and a variety of different data reading arrangements for the meters located at the user's site. Disadvantage of this prior art is the requirement to read multiple meters at the user's site, one meter for each utility service furnished to each user, having been detailed above.

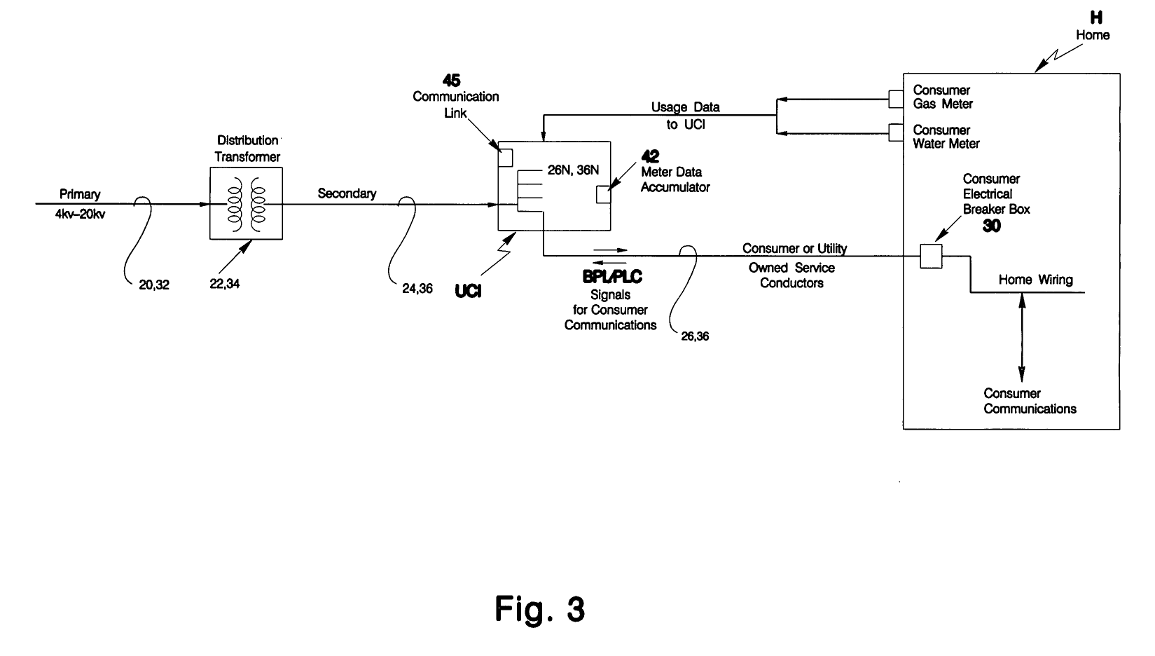

In the present invention, a usage, data collection and communication unit designated, UCI according to the present invention, is shown. The UCI, as will be described, measures utility usage data for electrical power service, plus other utility and communication services, provided to one or more consumers as shown schematically in FIG. 3. The unit UCI in FIG. 3 is shown schematically for either a URD or an overhead powerline distribution arrangement. When the power distribution arrangement is underground residential distribution like that of FIG. 1, the unit UCI of the present invention is usually provided as a replacement for the secondary pedestal P. When the unit UCI of the present invention is used in connection with an overhead distribution arrangement like that of FIG. 2, the unit UCI is mounted in close proximity to the distribution transformer 34, either on the same pole or otherwise quite near the transformer 34.

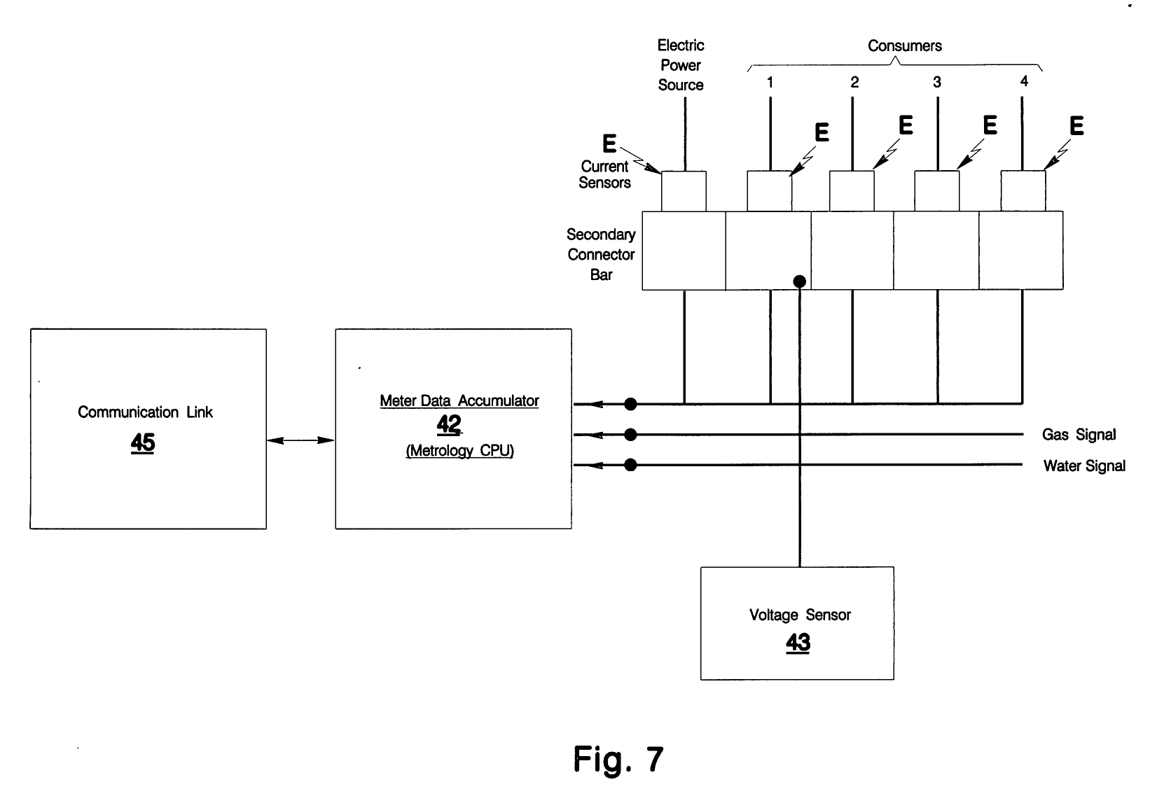

The unit UCI of the present invention serves to integrate the data collection and reporting of utility usage data from electric and other utilities and thus is referred to as a utilities communication integrator (UCI). The UCI also facilitates the injection of communications signals onto the service conductors from multiple communications services through a communication link module 45 (FIG. 7) according to the present invention. The UCI provides for injection of communications signals onto the service conductors 26. The communications signals may be from multiple sources. For example, the communications signals may be of various types of telecommunication technologies such as BPL, PLC, WIFI, digital, fiberoptic and other signals, as will be set forth.

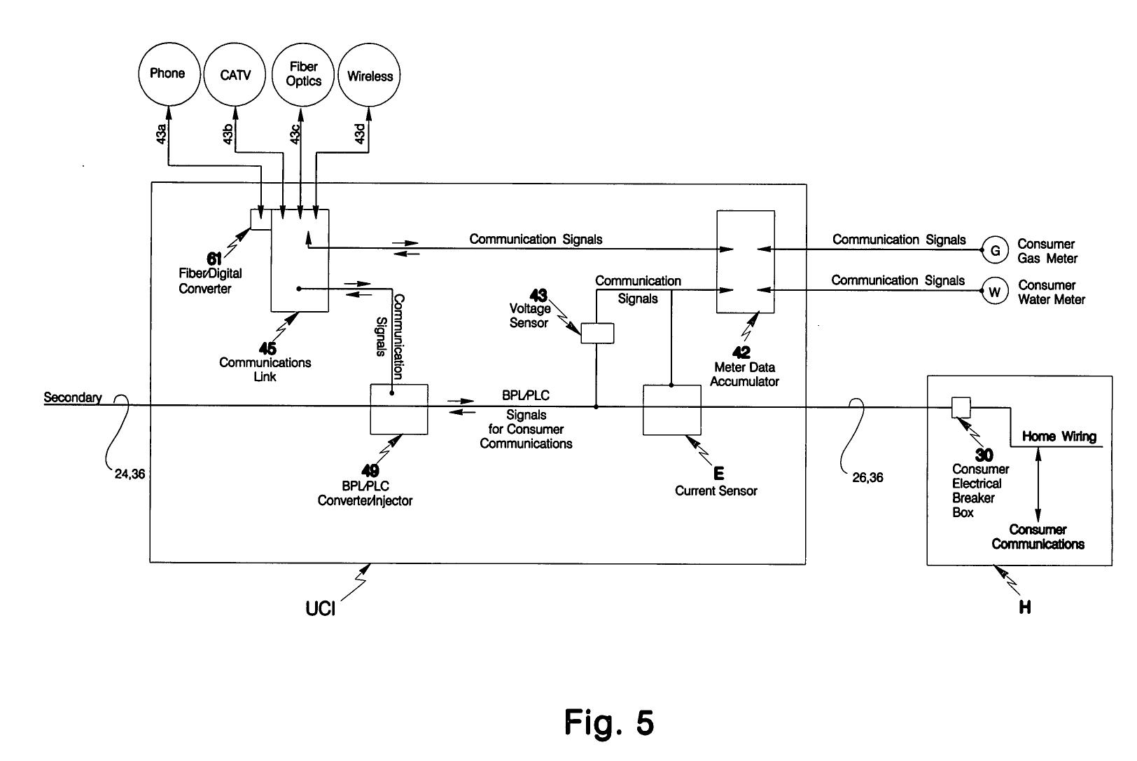

The unit UCI (FIGS. 3 and 5) receives a voltage signal and includes a separate electrical current sensor E (FIG. 7) for obtaining data indicating the amount of electrical power flowing from the distribution transformers 22 or 34, as the case may be, over the secondary line 36 to each of the users or consumers. In FIG. 3, the electric lines shown schematically as secondary line 36 or primary line 20, 32, are typically several conductors.

The electrical current sensor E of the present invention, whether for multi-phase or single phase, preferably takes the form of a current flow sensor arranged on each one of the service conductors for each individual consumer. The current sensors of the electrical current sensor E may take the form of a current transformer to indicate sensed current flow through the service conductor, Hall effect sensor operating based on the Hall effect to generate a signal proportional to the amount of current flowing to the individual user. It should he understood that various types of metering chips, or other current sensing technology, such as those available from Cirrus Logic, Inc., of Austin, Tex. could be used, for example. The voltage level of power to the consumer is measured by a voltage transducer 43 (FIG. 5). The amount of current flowing over time, combined with the voltage, to an individual consumer or user is an accurate indication of power level and energy consumed. It should be understood that other types of current flow sensors, or other sensors or transducers may also be used to sense electrical power furnished to the users and consumers.

Readings from the individual electrical current sensors E are furnished to a meter data accumulator 42 (FIGS. 3, 5, 6 and 7) which stores data indicating the electrical energy usage provided to the consumer. The data accumulator 42 and its associated computer executable instructions or software are capable of storing, organizing and transferring various sets of data in the form of signals or other information media from various sources, organizing the data, time-stamping the data, and presenting the data to an intended recipient in the course of collection and communication of electrical energy usage data and other data and signals according to the present invention.

The meter data accumulator 42 includes a processor which operates under the control of a series of computer-executable instructions. The instructions may be contained in a memory of the meter data accumulator 42, or on magnetic tape, conventional hard disk drive, electronic read-only memory, optical storage device, or other appropriate data storage device. Also, the instruction may be stored on a data storage device with a computer readable medium, such as a computer diskette, having computer-executable instructions stored thereon.

The meter data accumulator 42 is connected by input/output interfaces as described below (FIG. 5) for data transfer purposes. The meter data accumulator 42 may be one of several types of digital processors, such as a laptop computer, processing circuit, processing chip or any suitable processing apparatus. For example, a Dell® brand laptop computer may serve as the CPU.

In FIG. 5, the electrical current sensor E is providing data to the meter data accumulator 42. The data could be transmitted via a NetGear Powerline XE102, a wall-plugged Ethernet bridge network adapter available from Netgear Inc. of Santa Clara, Calif., for example. It should be understood that a number of network adapters commonly commercially available could also be used, if desired. Typically, electrical voltage is also provided, as indicated at 43 by the voltage transducer/converter to the meter data accumulator 42. The current data and voltage data are combined, resulting in energy usage being provided to the meter data accumulator 42 and other components of the UCI.

The meter data accumulator 42 is also capable of receiving and storing usage data from other utilities, such as gas and water. Data readings from the meter data accumulator 42 are thus composite or integrated data readings representing meter usage data from the various utilities being served by the UCI for one or more utility consumers or users. The data from accumulator 42 provided to a communication link 45 (FIG. 7) where they are transmitted to a data collection facility. The transmitter type and communication medium may take a number of forms.

For example, the integrated metering data from accumulator 42 (FIG. 5) may be sent via the communications link 45 using multiple telecommunication technologies such as wire as indicated at 43a; coaxial cable as indicated at 43b; fiberoptic cable or other cable media as indicated at 43c; BPL, or broadband powerline carrier over lines 24 and 36; PLC, or power line carrier; or wireless, such as WIFI (Wireless Fidelity) as shown at 43d, or the like. Where fiberoptic signals are used as a telecommunications technology, the fiberoptic signals are converted to digital signals by a fiber-to-digital converter 61. Wireless communications may also be used. The data may be sent by way of a communications link module, as indicated at 45.

When power line carrier communication of some form is used, BPL/PLC converters/injectors (hop-on connectors) or other methodology, as shown schematically at 49 are provided. These devices transfer the meter usage data and other signals to the electrical utility conductors 24 or 36. The communications link module 45 provides for data readings transmission and makes available two-way interactive communication through the UCI, to the consumer, the utilities, and others. Finally, the UCI serves through the telecommunications technology of the foregoing types, as the point of communication for the consumer's telecommunication services (FIG. 5) such as CATV, telephone, BLP/PLC, wireless, or fiberoptics. Protocols typically used include twenty-four bit, two's complement for electric meter reading, and pooled serial for gas and electric metering, although it should be understood that others could be used as well. The protocol for control may be of the type known as polled and wait (i.e. no feedback status), but again it should be understood that others could be used.

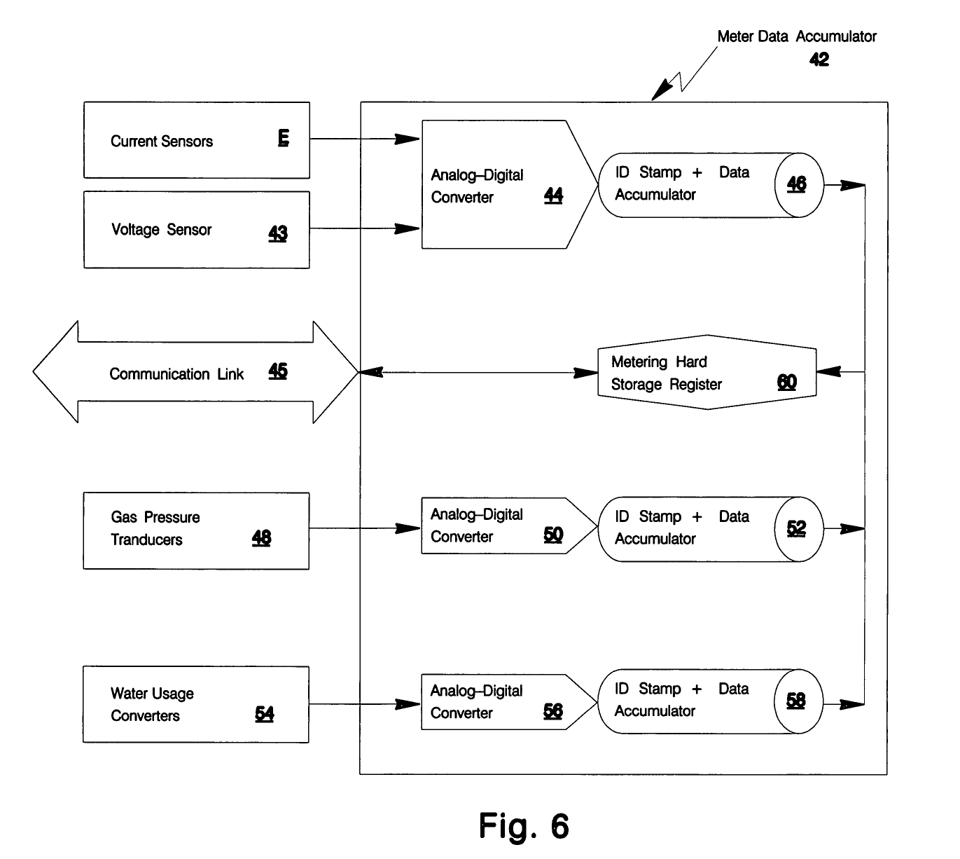

In FIG. 6, details of information flow in a UCI unit according to the present invention for gathering utility data for electrical, gas and water utility services are shown. The current sensor E for each individual consumer/user may be connected to an analog-to-digital (A/D) converter 44 which converts the readings of current flow combined with voltage, and thus energy usage, into a digital signal. Digital signals from the A/D converter 44 are provided as current flow readings and voltage readings, and thus electrical power or energy usage readings, for storage in a data accumulator 46 of the meter data accumulator 42. The data accumulator 46 accumulates readings of energy usage versus elapsed time and forms an electronic record of such usage. In the data accumulator 46, a user identifier code, stamp or prefix unique to the user or consumer being served is also added or included as an identifier to the usage data. The stored electronic is available for use in analysis and diagnostics of electrical devices or for other purposes.

Similarly, a gas pressure transducer 48 for each individual consumer/user being served may be connected to an A/D converter 50 and digital signals representing the amount of gas provided by the utility to consumer are provided and stored in a gas data accumulator 52 of the data meter accumulator 42. The gas data accumulator 52 for gas utility usage functions in a like manner to the electric data accumulator 46, storing usage data either as a function of time or accumulating cumulative usage data by periodic data samplings, and adding a consumer identifier stamp or code.

A water usage converter, such as a flow sensor 54, is provided for each individual consumer/user being served. The sensor 54 is connected to an A/D converter 56 where digital signals representing water consumption readings are formed. The digital water consumption signals indicating the amount of water provided to the consumer by the utility are stored in a water usage data accumulator 58, which functions in a like manner to the accumulators 46 and 52 storing usage data and applying user identifiers, stamps or codes.

Periodically at some suitable time interval, such as some number of minutes, data readings and consumer identifiers or codes from the data accumulators 46, 52, and 58 are transferred to a data storage register 60 where the utility usage readings and consumer identifiers are stored. Preferably, the memory of the data storage register 60 is of a stable form not susceptible to inadvertent erasure due to power surges or the like. At some suitable time period or interval, such as daily intervals or the like, usage data is transferred to the utility data collection facility via the communication link 45 (FIGS. 5 and 7) using any of the techniques described above.

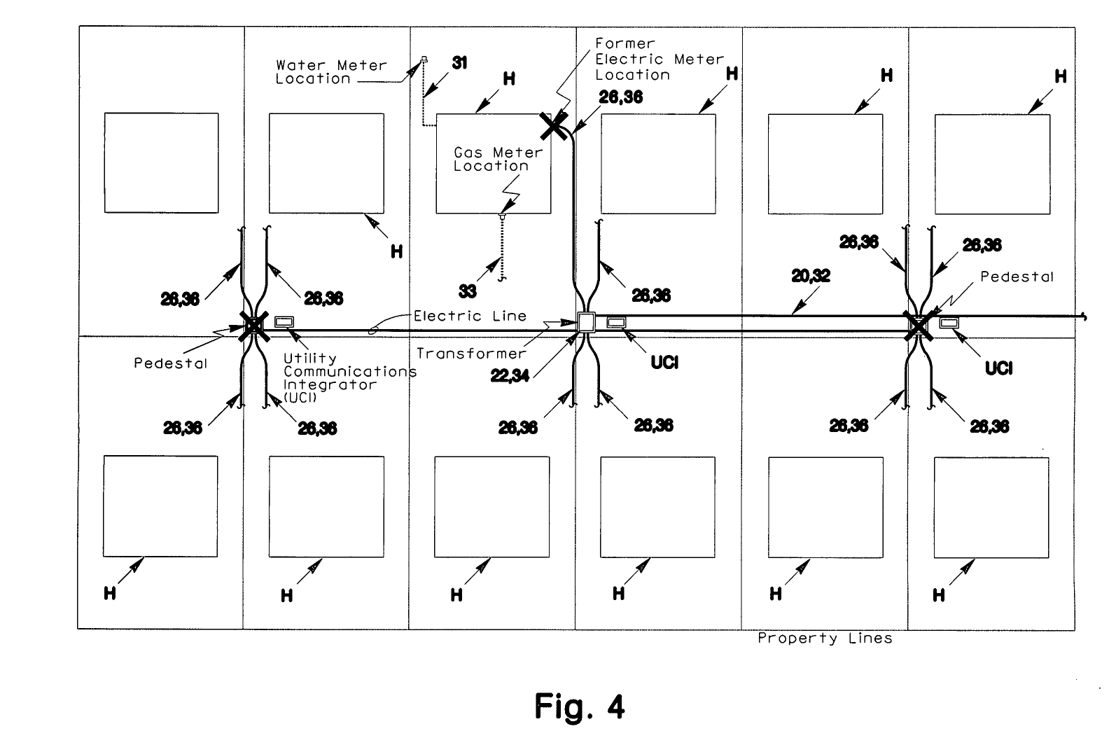

From the foregoing, it can be seen that the present invention is adapted for use in connection with a variety of utilities and with a variety of arrangements for furnishing electrical power or other utility commodities to a consumer or user's facility. As is indicated in FIG. 4, energy usage for a group of adjacent home sites H can be provided by a single UCI. The requirement for separate meter readings and technology for each of the various utilities to a home are no longer required. The “X” symbol in FIG. 4 indicates the locations where a kilo watt-hour meter would be located with a conventional metering arrangement. Rather, only the electrical line connection (such as 26, 36) to the various houses, as shown for one such house H, need be made.

As has been noted above, the UCI (FIG. 3) may replace the conventional secondary pedestal (FIG. 1) in connection with an underground residential or URD power distribution arrangement, or it may be a pole mounted unit in connection with overhead electrical power distribution arrangements. Additionally, the UCI of the present invention may be provided as a wall-mounted unit to facilities such as apartment buildings where there are multiple users, each requiring separate and individual billing service. With such an arrangement,-individual current flow sensors are provided by the UCI for each of the separate residents of the building or facility requiring separate billing. However, it is to be noted that there is no meter that needs to be read for any such user. Rather, the UCI of the present invention transmits the data readings for billing purposes to the same data collection facility as used for individual users, and there is no need for meter readings to take place.

As can be seen, the present invention provides a unit that measures electric (typically kilowatt-hours or kwh's) energy usage and serves as a collection device for other utility meter data (such as gas and water). The unit of the present invention integrates the data readings into a composite data reading for transmission to data collection facilities. Data communications may be made utilizing various telecommunications technologies, as described earlier. The unit of the present invention also reads utility meter data and interactively communicates with end user consumers or consumer devices. The present invention thus can be seen to provide a new process of collecting data regarding utility consumption, utilizing the UCI unit.

The UCI unit thus can be seen to include a plurality of meter ports and a memory for storing meter data from each metered user. In one embodiment, the UCI unit meters electric kilowatt hour consumption and other information for multiple consumers and stores information in memory for real-time or future retrieval. The UCI unit also collects consumption and other information from other meter devices (such as gas and water) through a data accumulator and stores information in memory for real-time or future retrieval. Consumers can readily access and/or receive usage information regarding demand, time of use, reliability, marketing and utility messages regarding product quality or service interruption.

With the present invention, utilities and consumers can thus have almost instantaneous access to any meter. Further, the conventional manual meter reading process for collecting readings is becoming both economically and operationally obsolete in favor of a more reliable process and utilizing new communication technology according to the present invention.

The unit UCI according to the present invention also provides other features and capabilities as well. The UCI permits monitoring performance of electrically powered devices or appliances which receive electrical energy from an electric energy provider or utility. Performance monitoring can include monitoring of energy usage by the appliance, as well as analysis, diagnostic or control functions. A number of electrical units, devices or appliances, whether of a residential or an industrial consumer, are provided with digital energy management controllers or monitors to reduce energy usage and possible waste. According to the present invention, they are collectively defined as devices. Usually the energy management controllers for such devices are digital microcontrollers or microprocessor based. The energy management controllers monitor and control energy usage by motors in the appliance, and also may provide signals indicating both usage and performance. These types of commercially available energy management controllers may be furnished as components from the original equipment manufacturer, or they may be separately installed. Examples of such devices or appliances for residential consumers include, for example, air conditioning units, evaporation coolers, household appliances, pool pumps and other appliances, usually driven by induction motors. The appliances or devices are connected to receive electrical energy by connection to the consumer electrical breaker box 30 through secondary wiring and electrical outlets in the consumer site H.

For this purpose, signals for control and performance monitoring are exchanged between the utility providing energy and the energy management controller, normally using BPL/PLC techniques, through the UCI. The data accumulator 42 stores a record of the performance data sent from the energy management controller or monitor over the service conductors 26, 36. The performance data is then transferred along with suitable identifier codes from the data accumulator 42 through the converter/injector 49 over the power delivery distribution lines 24, 36 or via communications link 45 to a data receiver/transmitter at the energy provider's facility for monitoring, storage, processing or analysis there as needed. Monitoring and control signals are exchanged from the energy provider to the appliances at the user or consumer's facility H. The signals are furnished as BLP/PLC signals over the same power distribution lines 24, 36 to the converter/injector 49 to the communication link module 45 and the data accumulator 42.

The unit UCI according to the present invention also enables demand side management of electrical energy usage at an energy consumer's facility. The converter/injectors 49 receive incoming control signals sent in BPL/PLC form over the power distribution lines 24, 36 via communications link 45 from the energy service providing utility. The incoming signals are addressed by suitable identifier codes to the particular user or groups of users. The processor of data accumulator 42 decodes the incoming signals and, if applicable, transfers the incoming control signals to the digital energy management controllers of the particular user or groups of users involved. The decoded signals then control or manage electrical energy consumption of equipment, units and devices at the user's facility.

The unit UCI also serves as a host device of a communication system for transferring received telecommunications from external services through service conductors to the user's facility from a variety of telecommunication technologies. Incoming signals from multiple telecommunications technologies including wire, as indicated at 43a; coaxial cable 43b; fiberoptic cable or other cable media 43c; or wireless technology, such as wireless fidelity 43d, are provided to incoming communication slots or ports of the communication link module 45. The incoming signals are converted into suitable format and transferred to the converter/injector 49 for transfer over the conductors 26, 36 to the service conductors of the energy consumer's facility. Adapters of the conventional type mentioned above are inserted into the service outlets of the user's facility to receive and convert the signals on the service conductors for transfer. The signals may be transferred, for example, to telephone handsets, radios, entertainment centers, computers, video displays, television units or other signal receivers or utilization devices for their intended use.

The unit UCI of the present invention also provides a communication system for two-way communication between the energy user or consumer at the facility H and the utility or other service provider furnishing electrical energy or other types of services to the user. The two-way communication through the UCI is performed via the service conductors 24, 36 or via communications link 45 and can be of a variety of types of information or data such as demand side management, marketing or power outage data.

Signals on the service conductors 24, 36 pass through the communication link module 45 which receives and transmits communications, either to the user from the service provider or from the provider to the user, depending on the origin of the communication. The communication link module 45 receives the message from data accumulator 42 which insures the proper address codes are present to identify that the user is the intended recipient or originator, and converts the data content of the message into proper format. The message from communications module 45 is connected by the signal converter/injector 49 which places the message onto the appropriate conductors for exchange, either receipt or transmittal, between the user and the energy service provider

The invention has been sufficiently described so that a person with average knowledge in the matter may reproduce and obtain the results mentioned in the invention herein. Nonetheless, any skilled person in the field or technique subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

That which is claimed is:

1. A usage and data collection unit for data of electrical power service provided to at least one consumer, comprising:
a sensor obtaining data including the amount of current flowing from a distribution transformer to the consumer for use;
a data accumulator storing electrical usage data for power service provided to the consumer from the distribution transformer;
a data transmitter transmitting stored electrical data readings to a data collection facility based on power service provided to the consumer.

2. The usage and data collection unit of claim 1, wherein the electrical power service to the consumer is by underground distribution through a secondary distribution transformer connected through the unit.

3. The usage and data collection unit of claim 1, wherein the electrical power service to the consumer is by overhead power line service through a pole-mounted secondary distribution transformer, and wherein the unit is mounted with the pole.

4. The usage and data collection unit of claim 1, wherein the sensor comprises a current flow sensor measuring the flow of electrical current from the distribution transformer.

5. The usage and data collection unit of claim 4, wherein the current flow sensor comprises a Hall effect current sensor.

6. The usage and data collection unit of claim 4, wherein the current flow sensor comprises a current transformer.

7. The usage and data collection unit of claim 1, wherein utility usage data is obtained of electrical power service provided to a plurality of consumers, and further including:
a plurality of electrical current sensors, each obtaining data indicating the amount of electric current flowing to a selected one of the plurality of consumers.

8. The usage and data collection unit of claim 7, wherein:
the data accumulator separately stores electrical energy usage data reading for the plurality of consumers.

9. The usage and data collection unit of claim 8, wherein:
the data transmitter transmits the stored electrical energy usage data for each of the plurality of consumers distinctly from usage data of others.

10. The usage and data collection unit of claim 1, wherein utility usage data is obtained for other utility commodities provided to the consumer, and wherein:
the data accumulator stores usage data of other utility commodities furnished to the consumer; and
the data transmitter transmits the stored usage data of other utility commodities to the data collection facility.

11. The usage and data collection unit of claim 10, wherein the other utility commodities comprise: gas

12. The usage and data collection unit of claim 10, wherein the other utility commodities comprise: water

13. The usage and data collection unit of claim 1, wherein:
the data transmitter and the data collection facility are connected with each other through a communications network.

14. The usage and data collection unit of claim 1, wherein:
the data transmitter communicates usage data to the data collection facility by wireless communication.

15. The usage and data collection unit of claim 1, wherein:
the data transmitter communicates usage data to the data collection facility by wire communication.

16. The usage and data collection unit of claim 1, wherein:
the data transmitter communicates usage data to the data collection facility by fiber communication.

17. The usage and data collection unit of claim 1, wherein:
the data transmitter communicates usage data to the data collection facility by broadband over powerline communication.

18. The usage and data collection unit of claim 1, wherein:
the data transmitter communicates usage data to the data collection facility by power line carrier communication.

19. A method of collection of utility usage data of electrical power service provided to at least one consumer from a secondary distribution transformer, comprising the steps of:
obtaining data indicating the amount of power flowing from the distribution transformer to the consumer for use;
storing the obtained electrical energy usage data of power service provided to the consumer from the distribution transformer;
transmitting the stored electrical energy usage data to a data collection facility based on power service provided to the consumer.

20. The method of claim 19, wherein the electrical power service to the consumer is by underground distribution through a pad mounted secondary distribution transformer.

21. The method of claim 19, wherein the electrical power service to the consumer is by overhead power line service through a pole-mounted secondary distribution transformer.

22. The method of claim 19, wherein the step of obtaining data comprises the step of measuring the flow of electrical current from the distribution transformer.

23. The method of claim 22, wherein the step of measuring the flow of electrical current is performed with a Hall effect current sensor.

24. The method of claim 22, wherein the step of measuring the flow of electrical current is performed with a current transformer.

25. The method of claim 19, wherein utility usage data is obtained of electrical power service provided to a plurality of consumers, and wherein the step of obtaining data comprises the step of:
obtaining data indicating the amount of power flowing to different ones of the plurality of consumers.

26. The method of claim 25, wherein the step of storing comprises the step of:
separately storing electrical energy usage data readings for the plurality of consumers.

27. The method of claim 25, wherein the step of transmitting comprises the step of:
transmitting the stored electrical energy usage data for each of the plurality of consumers distinctly from usage data of others.

28. The method of claim 19, wherein utility usage data is obtained for other utility commodities provided to the consumers, and further including the steps of:
storing usage data of other utility commodities furnished to the consumer; and
transmitting the stored usage data of other utility commodities to the data collection facility.

29. The method of claim 28, wherein the other utility commodities comprise: gas

30. The method of claim 28, wherein the other utility commodities comprise: water

31. The method of claim 19, wherein:
the step of transmitting is performed through a computer network.

32. The method of claim 19, wherein:
the step of transmitting is performed by wireless communication.

33. The method of claim 19, wherein:
the step of transmitting is performed by wire communication.

34. The method of claim 19, wherein:
the step of transmitting is performed by fiber communication.

35. The method of claim 19, wherein:
the step of transmitting is performed by broadband over powerline communication.

36. The method of claim 19, wherein:
the step of transmitting is performed by power line carrier communication.

37. A unit for monitoring of performance of electrically powered devices receiving energy from an electric utility, comprising:
a data accumulator storing performance data provided thereto by a monitor in at least one of the devices; and
a data transmitter transmitting stored performance data to a data collection facility of the utility for monitoring performance of the devices.

38. A method of monitoring performance of electrically powered devices receiving energy from an electric utility comprising the steps of:
storing performance data provided by a monitor in at least one of the devices; and
transmitting stored performance data to a data collection facility of the utility for monitoring performance of the devices.

39. A unit for enabling demand side management of electrical energy usage at an energy consumer's facility comprising:
a signal receiver for incoming control signals over power delivery conductors from an electrical power provider;
a processor for transferring the incoming control signals from the signal receiver over service conductors to control electrical energy consumption at the energy consumer's facility.

40. A method of enabling demand side management of electrical power consumption at an energy consumer's facility, comprising the steps of:
receiving incoming control signals over power delivery lines from an electrical energy provider;
transferring the incoming control signals from the signal receiver over service conductors to control electrical energy consumption at the energy consumer's facility.

41. A communication system for transferring telecommunications signals through service conductors of an energy consumer's facility, comprising:
a communications module receiving a signal from the telecommunications media; and
a signal injector transferring the received signal from the communications module onto the service conductors of the energy consumer.

42. A method of transferring telecommunications media through service conductors of an energy consumer's facility, comprising the steps of:
receiving a signal from the telecommunications media; and
transferring the received signal from the communications module onto the service conductors of the energy consumer.

43. A communication system for two-way communication of signals between a consumer and a services provider furnishing services to the consumer over a distribution network:
a communications module for receipt and transmittal of the communications signals between the service provider and the consumer; and
a signal transfer module for exchanging the communications signals between the service conductors and the communications module.

44. A method of two-way communication of signals between a consumer and a service provider furnishing services to the consumer over service conductors of an energy distribution network, comprising the steps of:
receiving the communications signals between the service provider and the consumer; and
exchanging the communications signals between the service conductors and the communications module.

45. A unit for remote control of electrically powered devices receiving energy from an electric utility at an energy user's facility comprising:
a signal receiver for remote control signals for control of the electrically powered devices;
a processor for transferring the received remote control signals from the signal receiver over electrical service conductors to control the electrically powered devices at the energy consumer's facility.

46. A method of remote control of electrically powered devices receiving energy from an electric utility at an energy user's facility, comprising the step of:
receiving remote control signals for control of the electrically powered devices;
transferring the received remote control signals over electrical service conductors to control the electrically powered devices at the energy consumer's facility.
